(19) United States
(12) Patent Application Publication
(10) Pub. No.: US 2019/0147555 A1
(43) Pub. Date: May 16, 2019

(54) Block Chain Technology Products Circulation Patent Innovation to Promote Methods

(71) Applicant: Yapeng LU, Hebei Province (CN)

(72) Inventor: Yapeng LU, Hebei Province (CN)

(21) Appl. No.: 15/975,060

(22) Filed: May 9, 2018

(30) Foreign Application Priority Data
Nov. 13, 2017 (CN) 01711155326.1

(51) Int. Cl. G06Q 50/18; H04L 9/06; G06Q 40/06

(52) U.S. Cl. CPC G06Q 50/184; G06Q 40/06; H04L 9/0637

(57) ABSTRACT

The invention discloses a blockchain technology product circulation patent innovation promotion method, which comprises an inventor, an administrative agency, a rights protection cooperation party, a patent using party and a patent exchange, and the inventor entrusts all the rights of the patent right to the management agency Operations management, including promotion, rights protection; the management agency to assess the patent content, to give the inventor some patent coins: and the patent coin can be traded in the patent exchange, the inventor can obtain legal money. Under the condition that the whole people are involved in the invention of innovation, the invention has a large number of patents owned by the whole people and is no longer a one-to-one patent administration, which will publicize expectations of all mankind.

### TECHNICAL FIELD

The invention is applied to all kinds of wholesale markets and various commercial operation fields, and specifically relates to a method for promoting innovation of product circulation patents of blockchain technology.

### BACKGROUND OF THE INVENTION

Science and technology are the primary productive forces. China's wholesale market, especially the circulation mechanism of agricultural products wholesale markets, is still in its infancy. It is difficult to keep up with the requirements of the times and its desire for scientific and technological innovation is very strong. At the same time, various innovative talents have developed innately But it is hard to bear the cost of patent application and the right of forensic safeguard so that individual scientific and technical personnel are unwilling to apply for technological innovation and the application of blockchain technology so that scientific and technical personnel can warm their body and make more technologies available to enable even more Many technologies can be extended to applications so that the general public can fully participate in the trend of technological innovation and promote scientific and technological innovation while enjoying the convenience and benefits brought by science and technology. To sum up, so I designed a product chain patent blockchain technology to promote innovation.

### CONTENT OF THE INVENTION

In order to solve the above existing problems, the present invention provides a method for promoting innovation of product circulation patents of blockchain technology.

The present invention is achieved by the following technical solutions:

A method for promoting innovation of product circulation patents based on blockchain technology, including inventors, regulatory agencies, rights activists, patent users, and patent exchanges. The inventor entrusts all the rights of the patent to the management and administration of the patent, including Promoting and safeguarding rights; the management institution evaluates the content of the patent and grants the inventor the patent coin: and the patent coin can be traded to a patent exchange, and the inventor can obtain the legal currency: the rights protection cooperation partner IPR innovation masses) obtained the authorization of all IPR promotion through the examination and approval of the regulatory agencies; 50% of the patent license fee paid by the user of the patent as the fee for rights protection was obtained by the rights protection cooperation partner; and the patent user paid The remaining 50% of the patent license fee is delivered to the regulatory agency which distributes (ie distributes the dividends) based on how many patent coins held by each of the traders.

As a further optimized solution of the present invention, the management institution has a large number of patent rights, promoting the use of patents, promoting technological innovation, promoting decentralization and universal participation in rights protection and usufruct.

As a further optimized solution of the present invention, the patent interest held by the regulatory body is traded on a patented exchange according to 20% of the number of issued patent coins and the operation of the management institution is maintained; and the total amount of the patent coin is within a certain limit Within, to ensure the investor's expectations.

As a further optimization solution of the present invention, any individual may participate in the trading of the patent coin. As the number of patent rights represented by the patent coin increases and the number of patent royalty fees obtained increases, the number of patent coins will continue Appreciation, individuals involved will get the corresponding profits.

Compared with the prior art, the invention has the following beneficial effects: Under the condition that the whole people participate in the invention of innovation, the entire people have a large number of patents, and are no longer one-on-one patent management, which will publicize the expectation of all mankind. The invention of the patent coin will enable different patent rights and patent rights of different inventors to use one kind of token to reflect the value, realize the heating of Baotuan patent rights protection, and promote the desire of patent application. And because the patent coin has knowledge Endorsement of property rights, on behalf of the value, is no longer a meaningless virtual currency, patent coin exchange registration management, refused to be used for illegal purposes. The invention of the patent coin will solve the problem of shortage of funds and promotion of many scientists, inventors, especially poor science and technology personnel. With the invention of China into the world, in the international registration, in the process of globalization, the patent money has its own The universality and standardization will help China's science and technology quickly occupy the world's highlands.

### BRIEF DESCRIPTION OF THE DRAWINGS

FIG. 1 is a structural connection diagram of the present invention.

The figure: 1, the inventor; 2, the management agencies; 3, the rights of cooperation parties; 4, the patent users; 5, the patent exchange;

### DETAILED DESCRIPTION

The present invention is further described in detail below with reference to the accompanying drawings and specific embodiments:

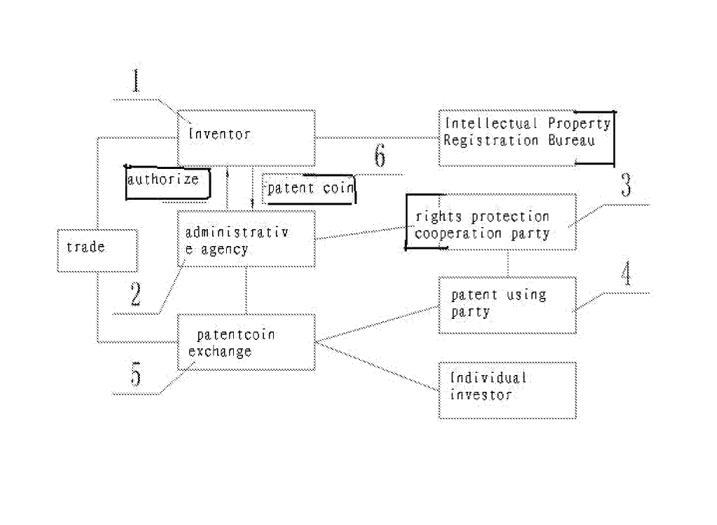

As shown in FIG. 1, a method for promoting innovation of product circulation patents based on blockchain technology includes inventor (1), regulatory agency (2), rights activist (3), patent user (4) and patent exchange (5) The inventor (1) entrusts all the rights of the patent right to the management agency (2) for operation and management, including promotion and rights protection; the management institution (2) The patent (6) can be traded to the patent exchange (5), and the inventor (1) can obtain the legal tender: the rights protection cooperation partner (3) (4) to obtain 50% of the patent license fee paid by the patent user (4) as the fee for the rights protection, and (3) the rights holder; and The remaining 50% of the patent license fee paid by the patent user (4) is delivered to the management institution (2); the management institution (2) distributes (ie distributes the dividends) according to the number of patent coins held by each of the traders; The regulatory agency (2) has a large number of patents, promote the use of patents, promote technological innovation, promote decentralization, universal participation rights (2) holds the patent (6) in the patent exchange (5) according to 20% of the number of issued patent coins (6), and maintains the operation of the management agency (2); And the patent coin (6) generally guarantees investors' expectations within a certain quota; any individual may participate in the trading of the patent coin (6), and as the patent represented by the patent coin (6) More and more rights, more and more patent licensing fees, patent coins (6) will continue to appreciate, individuals involved will get the corresponding profits.

In the embodiment of the invention, the invention has a large number of patents owned by the whole people without any one-on-one patent administration under the condition that all the people are involved in the invention of innovation, and will publicize the expectation of all mankind. The invention of the patent coin will enable different patent rights and patent rights of different inventors to use one kind of token to reflect the value, realize the heating of Baotuan patent rights protection, and promote the desire of patent application. And because the patent coin has knowledge Endorsement of property rights, on behalf of the value, is no longer a meaningless virtual currency, patent coin exchange registration management, refused to be used for illegal purposes. The invention of the patent coin will solve the problem of shortage of funds and promotion of many scientists, inventors, especially poor science and technology personnel. With the invention of China into the world, in the international registration, in the process of globalization, the patent money has its own The universality and standardization will help China's science and technology quickly occupy the world's highlands.

The basic principles, main features and advantages of the invention have been shown and described above. It should be understood by those skilled in the art that the present invention is not limited to the above embodiments, and the above embodiments and description only illustrate the principle of the present invention. Without departing from the spirit and scope of the present invention, the present invention also has Various changes and modifications which fall within the scope of the claimed invention. The scope of protection demanded by the present invention is defined by the appended claims and their equivalents.

1. A block chain technology product innovation method for promoting patent circulation, including inventors, regulatory agencies, rights protection partners, patent users and patent exchanges, characterized in that: the inventor of the patent rights of all entrusted management agencies Operation and management, including promotion and safeguarding of rights; the management institution evaluates according to the contents of the patent and grants the inventor the patent coin: and the patent coin can be traded to the patent exchange, and the inventor can obtain the legal currency: the rights protection cooperation partner (That is, all the people concerned with IPR innovation) obtain the authorization of all IPR promotion through the examination and approval of the regulatory agencies; 50% of the patent license fee paid by the user of the patent as the fee for rights protection is obtained by the rights protection cooperation party; and the patent The remaining 50% of the patent license fee paid by the user side is delivered to the regulatory agency which distributes (ie distributes the dividends) according to the amount of patent coins held by each of the traders.

2. A block chain technology product circulation patent innovation promotion method according to claim 1, characterized in that: the management agencies have a large number of patents, promote the use of patents, promote technological innovation, promote decentralization, participation of all Rights and the right to use.

3. A block chain technology product circulation patent innovation promotion method according to claim 1, characterized in that: the management institution holds the patent coin according to the issue of patented currency 20% of the number of transactions in the patent exchange, To maintain the management of the operation of institutions; and the patent coin in a certain amount of the overall, to ensure investor expectations.

4. A block chain technology product circulation patent innovation promotion method according to claim 1, characterized in that: the patented currency trading process any individual can participate in, as the patented patent more representative The more patent licenses you get, the more you get, the more the patent coins will appreciate, and the individuals involved will get the corresponding profits.
